(19) United States
(12) Patent Application Publication
(10) Pub. No.: US 2018/0207790 A1
(43) Pub. Date: Jul. 26, 2018

(54) MULIT-TASKING TOOL STORAGE AND ASSEMBLY STATION

(71) Applicant: Richard L. Daniel, Brooksville, FL (US)

(72) Inventor: Richard L. Daniel, Brooksville, FL (US)

(21) Appl. No.: 15/499,470

(22) Filed: Apr. 27, 2017

Related U.S. Application Data
(60) Provisional application No. 62/450,604, filed on Jan. 26, 2017.

(51) Int. Cl. B25H 3/00

(52) U.S. Cl. CPC B25H 3/006; B25F 3/00

(57) ABSTRACT

A multi-tasking tool storage and assembly station includes a generally rectangular-shaped upper body section having a plurality of spaced apart apertures extending from the top surface through the bottom surface, and a lower body section having a similar shape and size to the upper body section. The lower body section includes a plurality of spaced apart indentations along a top surface thereof. A plurality of elongated hollow channels are disposed between the apertures and indentations to form protective channels for receiving and securing any number of universal attachments for a multi-tasking tool. a pair of tool slots are positioned along the upper body section. The tool slots each including a shape and size that is suitable for receiving a motor unit of the multi-tasking tool and a large attachment.

13

### CROSS-REFERENCE TO RELATED APPLICATIONS

This application claims the benefit of U.S. application Ser. No. 62/450,604 filed on Jan. 26, 2017, the contents of which are incorporated herein by reference.

### TECHNICAL FIELD

The present invention relates generally to storage devices, and more particularly to a device for storing and assembling multi-tasking tools.

### BACKGROUND

The statements in this section merely provide background information related to the present disclosure and may not constitute prior art.

In recent years, many tool and equipment manufacturers have begun to provide multi-tasking tools for use by home and/or professional landscapers. These tools typically feature a single engine that is equipped with a universal power train for engaging a plurality of interchangeable attachments such as leaf blowers, edgers, trimmers, cultivators, hedge trimmers and sweepers, for example.

Although these systems are extremely useful for their intended purposes, their irregular shapes and sizes can be problematic to store and/or transport. Moreover, many users complain that it is difficult to install or swap the attachments without the aid of another person to physically hold the power train.

The present invention, directed to a multi-tasking tool storage and assembly station provides a novel and innovative solution to the above noted problems. The manner by which will become more apparent in the description which follows, particularly when read in conjunction with the accompanying drawings.

### SUMMARY OF THE INVENTION

The present invention is directed to a multi-tasking tool storage and assembly station. One embodiment of the present invention can include a generally rectangular-shaped upper body section having a plurality of spaced apart apertures extending from the top surface through the bottom surface. The station also includes a lower body section having a similar shape and size to the upper body section. The lower body section includes a plurality of spaced apart indentations along a top surface thereof. A plurality of elongated hollow channels are disposed between the apertures and indentations to form protective channels for receiving and securing any number of universal attachments for a multi-tasking tool.

Another embodiment of the present invention can include a pair of tool slots that are positioned along the upper body section. The tool slots each including a shape and size that is suitable for receiving a motor unit of the multi-tasking tool and a large attachment, such as a blower unit, for example.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of the multi-tasking tool storage and assembly station in accordance with one embodiment of the invention.

FIG. 2 is a perspective view of the upper body section of the multi-tasking tool storage and assembly station, in accordance with one embodiment of the invention.

FIG. 3 is a perspective view of the lower body section of the multi-tasking tool storage and assembly station, in accordance with one embodiment of the invention.

FIG. 4 is a perspective view of the multi-tasking tool storage and assembly station in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described throughout this document, the term multi-tasking tool is intended to refer to any type of tools or equipment having various interchangeable components. Several nonlimiting examples of such devices which can be used with the below described station include the Multi-Task Tool System that is commercially available from STIHL, and the Power Head system that is commercially available from ECHO. Of course, any number of other such systems and/or components can also be utilized with the below described station without undue experimentation.

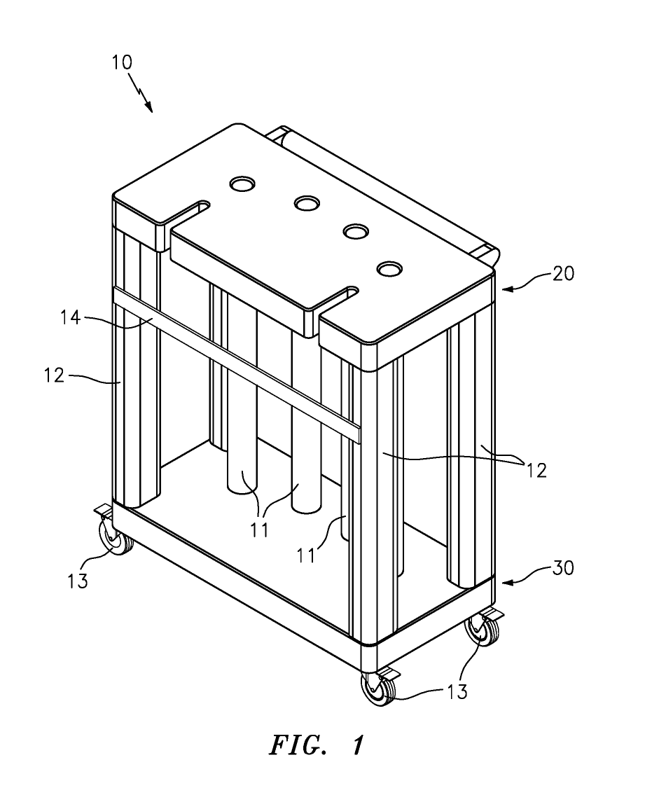

FIGS. 1-4 illustrate various embodiments of a multi-tasking tool storage and assembly station 10. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 illustrates one nonlimiting embodiment of the station 10 that is useful for understanding the inventive concepts disclosed herein. As such, the station 10 can include, essentially, an upper station section 20, and a lower station section 30 that are connected by a plurality of hollow channels 11.

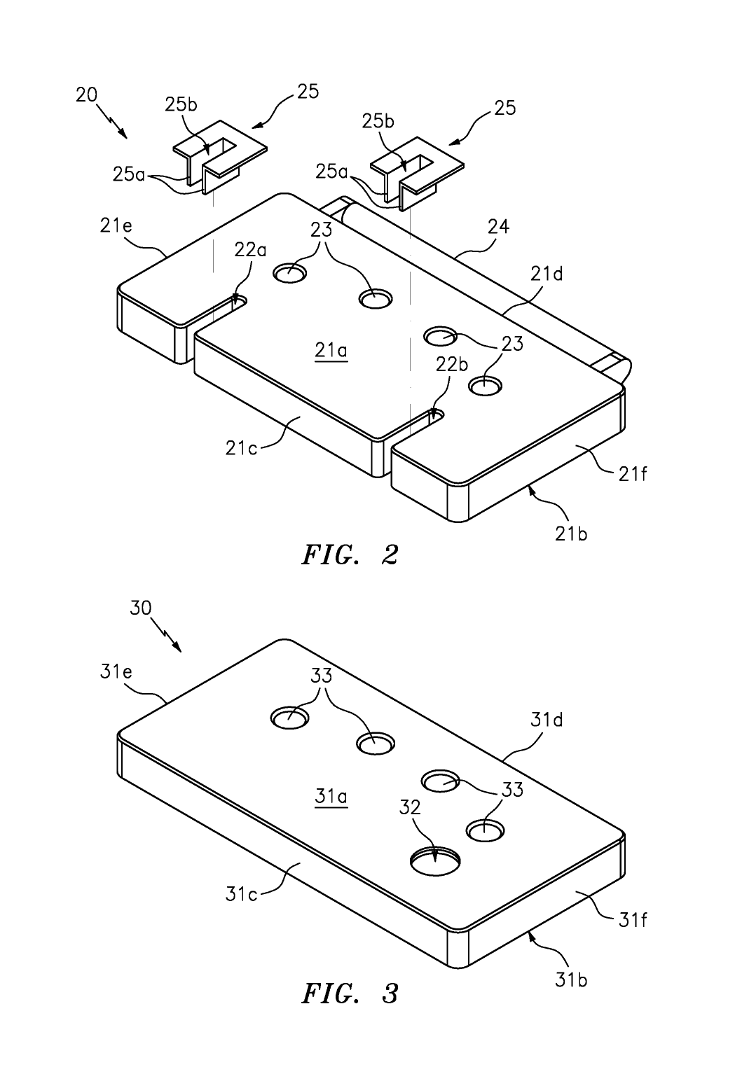

As shown in FIG. 2, the upper station section 20 can include an elongated, generally rectangular member having a flat top surface 21a, a bottom surface 21b, a front end 21c, a back end 21d, and a pair of opposing side sections 21e and 21f. As described herein, the upper station section can be formed from materials that are, for example, relatively strong and stiff for their weight. Several nonlimiting examples include, but are not limited to natural materials (e.g., various types of wood), various metals or metal alloys (e.g., aluminum, steel, titanium, or alloys thereof), plastic/polymers (e.g., high-density polyethylene (HDPE) or polyethylene terephthalate (PET)), or composite materials (e.g., carbon fibers in a polymer matrix, fiberglass, etc.).

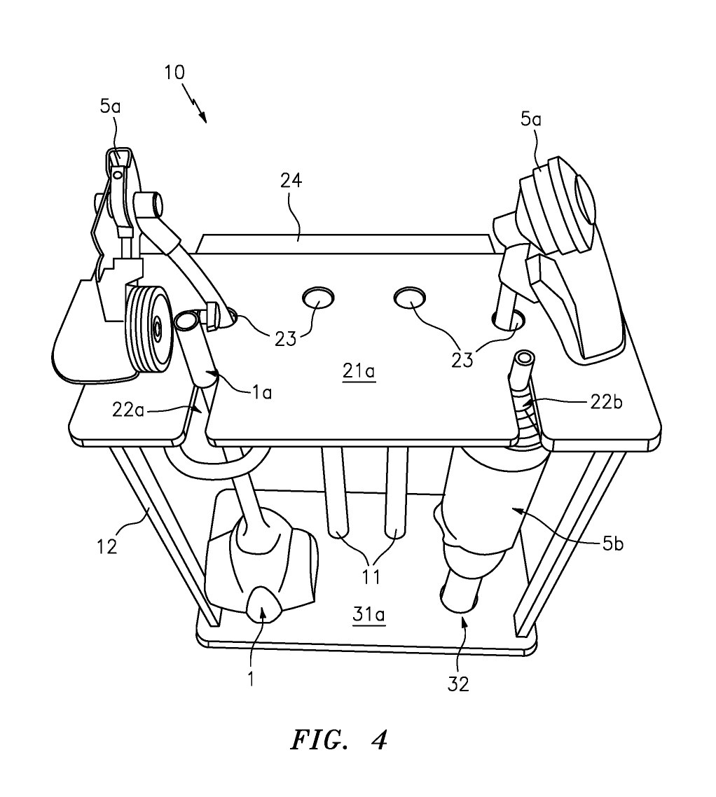

In either instance, a plurality of tool slots, such as those illustrated at 22a and 22b, for example, can be provided along the upper station section. In the preferred embodiment, the tool slots can extend from the front end 21c toward the back end 21d, but other locations are contemplated. The slots can include any number of different shapes and sizes, and can function to receive various portions of a multi-task tool, such as the elongated shaft of the motor unit 1, for example. Of course, the slots can also be used to receive and hang large tool attachments such as blower units 5b, for example (See FIG. 4). To this end, each of slots 22a and 22b can include substantially identical shapes and sizes, or can include dissimilar shapes and/or sizes to each other.

In one embodiment, one or more couplers 25 can be removably positioned within or along each of the slots 22a and 22b via arms 25a. Each of the couplers can be provided with an opening 25b having a different shape, or dimension than slots 22a and 22b, so as to accommodate differences in shapes, sizes and types of attachments offered by different multi-tool manufacturers.

A plurality of apertures 23 can be disposed along the upper station section, and can extend from the top surface 21a through the bottom surface 21b. Each of the apertures can include a dimension suitable for receiving the shaft portion of a multi-tasking tool attachment 5a, so as to allow the same to be positioned within the aperture.

An elongated bracket 24 can extend outward from the back end 21d of the upper station section. Depending on the intended use of the station, the bracket 24 can function to receive fasteners through a plurality of transverse apertures (not illustrated), so as to allow the station to be physically secured to the wall of a home or landscape vehicle, for example. Alternatively, the elongated shape of the bracket 24 can function as a handle for allowing a user to easily move the cart via the optional casters 13 that can be secured onto the lower station section.

As shown in FIG. 3, the lower station section 30 can also include an elongated, generally rectangular member having a generally flat top surface 31a, a bottom surface 31b, a front end 31c, a back end 31d, and a pair of opposing side sections 31e and 31f. The lower station section will preferably be constructed from an identical material as the upper station section 20, and will preferably include an identical shape and size therewith. Such a feature allows the station to be packaged and shipped in a uniform and fully collapsed state. Of course, other embodiments are contemplated wherein the upper and lower sections include different construction materials and/or shapes and sizes.

In one embodiment, an indentation 32 can be provided along the top surface 31a, at a location directly beneath the slot 22b. The indentation can work in conjunction with the slot to allow the station to securely receive larger tool attachments such as the blower 5b, illustrated below.

As shown, the lower station body 30 can include a plurality of indentations 33 disposed along the upper surface 31a. Each of the indentations 33 can include a location on the lower station body that is in-line with one of the apertures 23 on the upper station body.

As shown best in FIG. 1, a plurality of elongated hollow tubular members 11 can be aligned with a single aperture 23 at the top end, and a single indentation 33 at the bottom end, so as to form a continuous channel extending from the top of the station to the bottom of the station. Such a feature forming an elongated channel that advantageously provides protection against damage to the entire portion of the tool attachment located therein.

In one embodiment, the station 10 can also include any number of leg sections 12 which can be located along the corners of the station between the upper and lower bodies 20 and 30, respectively. Although not specifically illustrated, other embodiments of the station 10 are contemplated wherein the leg sections 12 are replaced with additional tubular members 11 and corresponding apertures and indentations along the upper and lower body sections. Such a feature can advantageously support the upper body section, while simultaneously providing additional channels for receiving and storing additional attachments.

As noted above, the station 10 is designed to allow a user the choice of mounting the device to a structure, or using as a portable cart. As such, a plurality optional casters 13 can be secured along the bottom end of the lower station body, to facilitate movement of the same.

Additionally, one or more adjustable retention straps 14 can be provided along the front end of the cart so as to prevent objects located in the slots from falling off. The straps preferably extending between two of the leg sections.

FIG. 4 illustrates one embodiment of the multi-tasking tool storage and assembly station 10 in operation. As shown, when the device is fully assembled, the motor unit 1 of a multi-tasking tool can be suspended from slot 21a, and a large attachment such as the illustrated blower unit 5b can be positioned within slot 22b, and the bottom end thereof can rest in the indentation 32. Finally, any number of tool attachments 5a can be secured within the protective channels defined by a single aperture 23 and member 11.

As shown, when the motor unit 1 is positioned within one of the slots, the connector portion 1a of the drivetrain is secured above the top end of the upper body section 21a. As such, a user attempting to remove, change or install an attachment onto the motor unit 1 can do so without the aid of an assistant, as the shape and size of the slot is designed to conform to the shape of the connector portion, thereby preventing the same from moving, swaying or rotating.

Accordingly, the above described multi-tasking tool storage and assembly station provides a novel means for storing, moving and/or assembling multi-tasking tools.

While the dimensions of all of the elements are not critical, in the preferred embodiment the upper body section can include a length (e.g., distance between sides 21e and 210 of approximately 32 inches; and a depth (e.g., distance between front and back ends 21c and 21d) of approximately 16 inches.

The opening defined by slots 22a and 22b preferably include a depth of approximately 5 inches and a width of approximately 1 inch. Such dimensions being complementary to the dimension of the connector portion of the motor unit and blower connector of a STIHL KombiSystem Multi-Tool.

The cross-section interior diameter of each tubular member 11, and the diameter of each of the apertures 23 preferably being 2.5 inches. Such dimensions being suitable for receiving the elongated shafts of any number of multi-tool attachments that are available from STIHL.

Although described above with regard to specific dimensions and/or construction materials for STIHL, this is for illustrative purposes only. As such, any number of other dimensions and/or construction materials are also contemplated, so as to accommodate Multi-Tool systems produced by other manufacturers.

As described herein, one or more elements of the station 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A tool storage and assembly station, said station comprising:
an upper body section having a plurality of spaced apart apertures extending from a top surface to a bottom surface thereof;
a lower body section having a plurality of spaced apart indentations along a top surface thereof, said upper body section and lower body section being positioned in a parallel orientation and being separated by a first separation distance;
a plurality of elongated hollow channels having a top end that is in communication with one of the spaced apart apertures, and a bottom end that is in communication with one of the spaced apart indentations, each of the spaced apart apertures and elongated hollow channels includes a dimension suitable for receiving a universal attachment of a multi-tasking tool; and
a first tool slot that extends from a front end of the upper body section towards a back end of the upper body section, said first tool slot including a shape and dimension that is complementary to a shape and dimension of a connector portion of a motor unit of a multi-tasking tool system, and
wherein the lower body section is configured to receive a motor of the motor unit, and the first separation distance is less than a length of the motor unit so as to position a drive train portion of the motor unit above the upper body section.

2-3. (canceled)

4. The station of claim 1, further comprising:
a second tool slot that extends from the front end of the upper body section towards the back end of the upper body section.

5. The station of claim 4, wherein the first and second tool slots include identical shapes and sizes.

6. The station of claim 4, wherein the first and second tool slots include dissimilar shapes and sizes.

7. The station of claim 4, wherein the second tool slot includes a shape and dimension that is complementary to a shape and dimension of a connector portion of a blower unit of a multi-tasking tool system.

8. The station of claim 7, further comprising:
an indentation that is positioned along the lower body section at a location directly beneath the second tool slot,
said indentation including a shape and size that is complementary to a shape and size of a second end of the blower unit located within the second tool slot.

9. The station of claim 1, further comprising:
an elongated bracket that extends outward from a back end of the upper body section, said bracket being configured to serve the dual purpose of a handle and a mounting bracket.

10. The station of claim 1, further comprising:
at least one coupler that is configured to removably engage the first tool slot,
each of the at least one couplers including an opening that is specifically sized and shaped to engage a motor unit of a different multi-tasking tool system.

11. The station of claim 4, further comprising:
at least one coupler that is configured to removably engage the second tool slot,
each of the at least one couplers including an opening that is specifically sized and shaped to engage a blower unit of a different multi-tasking tool system.

12. A tool storage and assembly station, said station consisting of:
an upper body section having a plurality of spaced apart apertures extending from a top surface to a bottom surface thereof;
a lower body section that is positioned parallel to the upper body section, and having a plurality of spaced apart indentations along a top surface thereof;
a plurality of leg sections that secure the upper body section above the lower body section at a first separation distance;
a plurality of elongated hollow channels having a top end that is in communication with one of the spaced apart apertures, and a bottom end that is in communication with one of the spaced apart indentations, each of the spaced apart apertures and elongated hollow channels includes a dimension suitable for receiving a universal attachment of a multi-tasking tool;
a first tool slot that extends from a front end of the upper body section towards a back end of the upper body section, said first tool slot including a shape and dimension that is complementary to a shape and dimension of a connector portion of a motor unit of a multi-tasking tool system, and
wherein the lower body section is configured to receive a motor of the motor unit, and the first separation distance is less than a length of the motor unit so as to position a drive train portion of the motor unit above the upper body section.
